(19) United States
(12) Patent Application Publication
(10) Pub. No.: US 2013/0255025 A1
(43) Pub. Date: Oct. 3, 2013

(54) WIPER BLADE ASSEMBLY

(71) Applicants: Kyoung Joon Song, Daegu (KR); Kyung Min Kim, Daegu (KR)

(72) Inventors: Kyoung Joon Song, Daegu (KR); Kyung Min Kim, Daegu (KR)

(73) Assignee: CAP CORPORATION, Daegu (KR)

(21) Appl. No.: 13/542,867

(22) Filed: Jul. 6, 2012

(30) Foreign Application Priority Data
Mar. 30, 2012 (KR) 10 2012 0033293

(51) Int. Cl. B60S 1/40; B60S 1/38

(52) U.S. Cl. 15/250.32; 15/250.4

(57) ABSTRACT

A wiper blade assembly includes an adhesive member to remove foreign substances on a window, an elastic member supporting the adhesive member, and cover members, each including a first end portion to cover an end of the elastic member and extending in a longitudinal direction. The first end portion of the cover member includes a front and side portions located at both sides of the front portion. The front portion includes an entrance/exit portion allowing entrance and exit of the elastic member, and each of the side portions includes a prop portion to support the elastic member. The prop portion includes a vertical prop portion to support a side surface of the elastic member, and a horizontal prop portion to support a lower surface of the elastic member. The wiper blade assembly is capable of facilitating the deformation of the elastic member when a wiper is operated.

### CROSS-REFERENCE TO RELATED APPLICATION

This application claims priority from Korean Patent Application No. 10-2012-0033293 filed on Mar. 30, 2012 in the Korean Intellectual Property Office, and all the benefits accruing therefrom under 35 U.S.C. 119, the contents of which in its entirety are herein incorporated by reference.

### BACKGROUND

1. Technical Field

The present inventive concept relates to a wiper blade assembly, and more particularly to the structure of a wiper blade assembly to facilitate the deformation of an elastic member when a wiper is operated.

2. Description of the Related Art

A wiper blade assembly is disposed on a windshield of a vehicle to remove foreign substances and wipe the rain water away in the event of rain in order to ensure a driver's field of view. The wiper blade assembly is driven by being connected to a wiper arm which is connected to a driving shaft connected to a wiper driving motor of the vehicle.

In this case, the wiper arm is coupled to the wiper blade assembly through a wiper connecter. Generally, the wiper blade assembly is provided with a clamp, and a connecter is fastened to the clamp. In a state where the connecter is fastened to the clamp, the wiper arm is fastened to the connecter.

Meanwhile, the types of the wiper blade assembly may be largely classified into a conventional type and a flat type according to the structure of the blade.

The conventional type is configured such that a plurality of yokes bent in a bow shape are fastened in upper and lower structures and an elastic force is applied to a rubber strip in contact with the windshield of the vehicle to press the windshield of the vehicle, and has been widely used in a conventional wiper blade assembly for a vehicle.

Meanwhile, the flat type is configured such that a single or a pair of elastic members is provided without using the above-mentioned yokes. Since the flat type has a simple structure, and looks beautiful when it is mounted on the vehicle, it is increasingly being used.

A general wiper blade assembly includes an adhesive member to remove foreign substances attached to a window, an elastic member to support the adhesive member, and cover members to cover ends of the elastic member.

In this case, the elastic member supporting the adhesive member is bent at a predetermined curvature when a wiper is not operated, and is deformed while varying the curvature according to the shape of the window when the wiper is operated.

However, in the general wiper blade assembly, since the cover members cover the ends of the elastic member, there is a problem such that the elastic member is difficult to be deformed when the wiper is operated.

### SUMMARY

The present invention provides a wiper blade assembly capable of facilitating the deformation of an elastic member when a wiper is operated.

The objects of the present invention are not limited thereto, and the other objects of the present invention will be described in or be apparent from the following description of the embodiments.

According to an aspect of the present invention, there is provided a wiper blade assembly comprising: an adhesive member to remove foreign substances attached to a window; an elastic member to support the adhesive member; and cover members, each including a first end portion to cover an end of the elastic member and extending in a longitudinal direction of the elastic member, wherein the first end portion of the cover member includes a front portion and side portions located at both sides of the front portion, wherein the front portion includes an entrance/exit portion allowing entrance and exit of the elastic member, and each of the side portions includes a prop portion to support the elastic member, and wherein the prop portion includes a vertical prop portion to support a side surface of the elastic member, and a horizontal prop portion to support a lower surface of the elastic member.

Further, in the wiper blade assembly of the present invention, an upper surface of the horizontal prop portion is in contact with a lower surface of the elastic member.

Further, in the wiper blade assembly of the present invention, the vertical prop portion is a part of each of the side portions of the first end portion, and the horizontal prop portion extends in a width direction from each of the side portions.

Further, in the wiper blade assembly of the present invention, the horizontal prop portion extends in a longitudinal direction to the front portion of the first end portion to guide the elastic member to the entrance/exit portion during the entrance and exit of the elastic member.

Further, the wiper blade assembly of the present invention further comprises a clamp coupled to the elastic member; a coupling cover including a receiving portion to cover the clamp; and an adapter attachable to and detachable from the receiving portion of the coupling cover.

Further, in the wiper blade assembly of the present invention, the cover member includes a second end portion rotatably connected to the coupling cover, and the end of the elastic member moves back and forth through the entrance/exit portion during rotation of the cover member.

Further, in the wiper blade assembly of the present invention, the adapter comprises: a body being inserted in the receiving portion; a support protrusion formed at one end of the body and supported by the coupling cover; and an elastic protrusion formed at the other end of the body, and engaged with and supported by the coupling cover.

Further, in the wiper blade assembly of the present invention, the coupling cover comprises: a first support portion located at a first side of the receiving portion to support the support protrusion; and a second support portion located at a second side of the receiving portion to support the support protrusion, wherein the first support portion has a shape and position corresponding to those of the second support portion.

Further, in the wiper blade assembly of the present invention, the coupling cover comprises: a first coupling groove located at a first side of the receiving portion to be fastened to the elastic protrusion; and a second coupling groove located at a second side of the receiving portion to be fastened to the elastic protrusion, wherein the first coupling groove has a shape and position corresponding to those of the second coupling groove.

As described above, according to the present invention, there is an effect of providing the wiper blade assembly capable of facilitating the deformation of an elastic member when a wiper is operated.

Further, according to the present invention, it is possible to provide the wiper blade assembly that can be applied to both LH and RH vehicles in fastening of the adapter and the coupling cover.

### BRIEF DESCRIPTION OF THE DRAWINGS

The above and other aspects and features of the present invention will become more apparent by describing in detail exemplary embodiments thereof with reference to the attached drawings, in which:

FIG. 1 is a perspective view showing a wiper blade assembly in accordance with the present invention;

FIGS. 2A to 2C are perspective views showing a cover member of a wiper blade assembly in accordance with a first embodiment of the present invention;

FIGS. 3A and 3B are perspective views showing a cover member of a wiper blade assembly in accordance with a second embodiment of the present invention;

FIG. 3C is a perspective view showing a cover member of a wiper blade assembly in accordance with a third embodiment of the present invention;

FIG. 3D is a perspective view showing a cover member of a wiper blade assembly in accordance with a fourth embodiment of the present invention;

FIGS. 4A to 4D are perspective views showing a wiper connecter in accordance with the present invention; and

FIG. 5 is a perspective view showing a coupling state of an adhesive member, an elastic member and a clamp of the wiper blade assembly in accordance with the present invention.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

The present invention will now be described more fully hereinafter with reference to the accompanying drawings, in which preferred embodiments of the invention are shown. The same reference numbers indicate the same components throughout the specification. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present invention.

The terminology used herein is for the purpose of describing particular embodiments only and is not intended to be limiting of the invention. The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Hereinafter, an embodiment of the present invention will be described in detail with reference to the accompanying drawings.

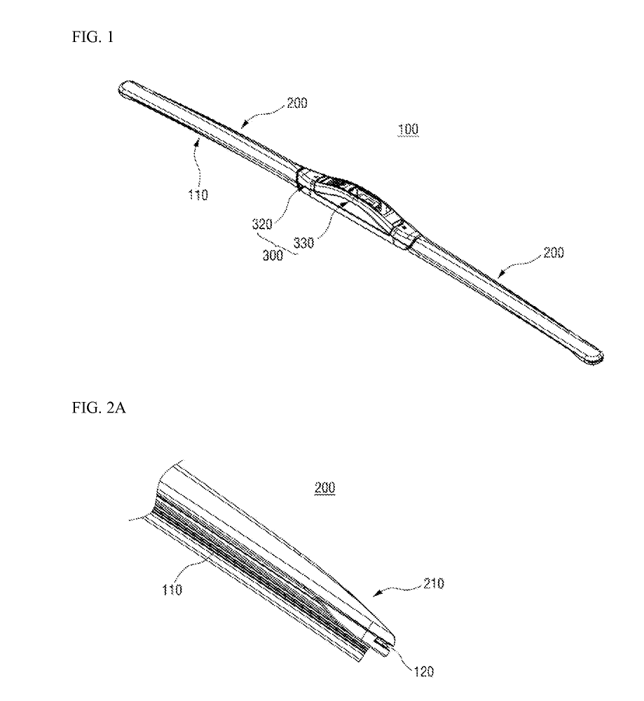

FIG. 1 is a perspective view showing a wiper blade assembly in accordance with the present invention, and illustrates a flat type wiper blade assembly.

In this case, as described above, the types of the wiper blade assembly may be largely classified into a conventional type and a flat type according to the structure of the blade. The conventional type is configured such that a plurality of yokes bent in a bow shape are fastened in upper and lower structures and an elastic force is applied to a rubber strip in contact with the windshield of the vehicle to press the windshield of the vehicle. The flat type is configured such that a single or a pair of elastic members is provided without using the above-mentioned yokes. In the present invention, no limitation is imposed on the type of the wiper blade assembly.

Referring to FIG. 1, a wiper blade assembly 100 in accordance with the present invention includes an adhesive member 110 which is made of a rubber material and in contact with the windshield of the vehicle, and a pair of cover members 200 which cover an elastic member (not shown) configured to support the adhesive member and ends of the elastic member, and a wiper connecter 300 which is located in a specific region in a longitudinal direction of the wiper blade assembly.

Further, the wiper connecter 300 may include a clamp (not shown) which is coupled to the elastic member, a coupling cover 320 which covers the clamp and includes a receiving portion, and an adapter 330 which is attachable to and detachable from the receiving portion of the coupling cover.

In this case, although a case where the wiper connecter is located in a central region in the longitudinal direction of the wiper blade assembly has been illustrated in the drawings, unlike the illustrated case, the wiper connecter may be located in an edge region if necessary. That is, no limitation is imposed on the location of the wiper connecter in the present invention.

Hereinafter, a configuration of the wiper blade assembly in accordance with the present invention will be described in detail.

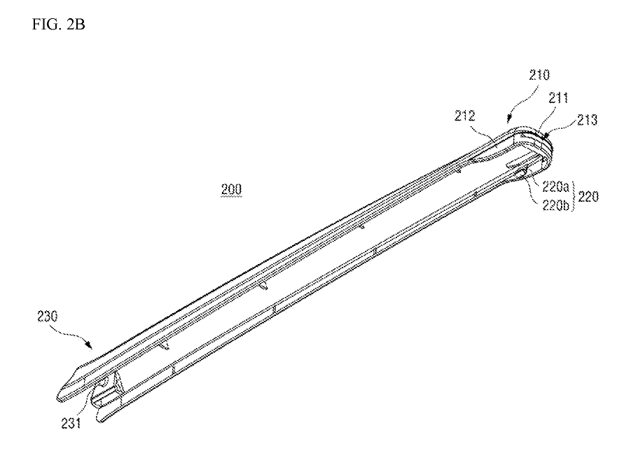

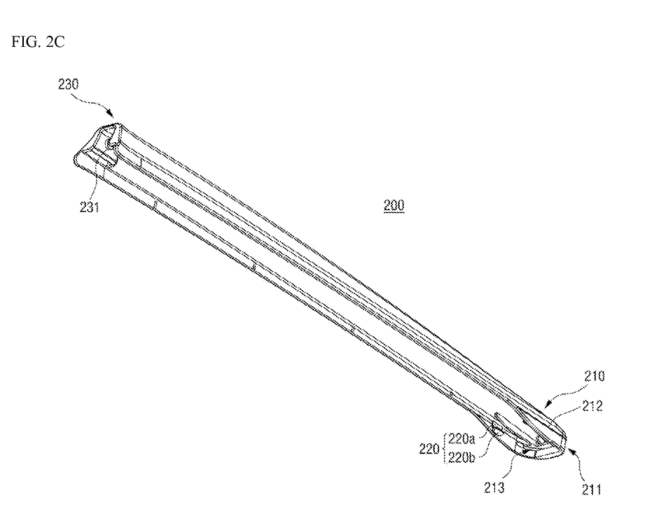

FIGS. 2A to 2C are perspective views showing a cover member of a wiper blade assembly in accordance with a first embodiment of the present invention. However, for convenience of explanation, FIG. 2A illustrates an adhesive member and an elastic member together with the cover member, and FIGS. 2B and 2C illustrate only the cover member without showing the adhesive member and the elastic member.

Referring to FIGS. 2A to 2C, a pair of the cover members 200 in accordance with the first embodiment of the present invention are located at both ends of an elastic member 120 to cover the ends of the elastic member 120. Hereinafter, the cover members of the present invention will be described using one of the pair of the cover members, e.g., the cover member located on the right side.

The cover member 200 in accordance with the first embodiment of the present invention may be formed to extend in a longitudinal direction of the elastic member while covering one end, e.g., a right end, of the elastic member 120.

In this case, in the present invention, a region of the cover member covering the end of the elastic member is defined as a first end portion 210.

That is, the cover member 200 may be formed to extend in the longitudinal direction of the elastic member 120 and include the first end portion 210 covering the end of the elastic member 120.

The first end portion 210 of the cover member includes a front portion 211 and side portions 212 located at both sides of the front portion. In the present invention, the front portion includes an entrance/exit portion 213 allowing entrance and exit of the elastic member.

More specifically, the wiper blade assembly according to the present invention includes the adhesive member 110 to remove foreign substances attached to a window, the elastic member 120 to support the adhesive member, and the cover members 200 to cover ends of the elastic member. The elastic member supporting the adhesive member is bent at a predetermined curvature when a wiper is not operated, and is deformed while varying the curvature according to the shape of the window when the wiper is operated.

In this case, when the elastic member is deformed while varying the curvature according to the shape of the window during the operation of the wiper, the entrance/exit portion 213 enables movement of the elastic member 120 in its longitudinal direction.

Generally, the elastic member is in a curved state at a predetermined curvature when the wiper is not operated, and the elastic member becomes flat to achieve a close contact between the adhesive member and the window when the wiper is operated. In this case, the cover members covering the ends of the elastic member may prohibit the elastic member from being flat.

However, in the present invention, since the entrance/exit portion is provided in the front portion of the cover member, the end of the elastic member can move in the longitudinal direction, thereby achieving a close contact between the adhesive member and the window.

Subsequently, referring to FIGS. 2A to 2C, each of the side portions of the cover member in accordance with the first embodiment of the present invention includes a prop portion 220 formed on the inner surface thereof to support the elastic member 120. The prop portion 220 may include a vertical prop portion 220a to support a side surface of the elastic member 120 and prevent the elastic member 120 from being separated laterally from the wiper blade assembly, and a horizontal prop portion 220b to support a lower surface of the elastic member 120 and prevent the support member from being separated downward from the wiper blade assembly.

That is, the prop portion 220 having an approximately “ [symbol] ” or “ [symbol] ” shape is formed on the inner side surface of the cover member. The prop portion 220 supports the side and lower surfaces of the elastic member 120 to prevent the elastic member from being separated laterally and downward from the wiper blade assembly.

More specifically, the prop portion 220 includes the vertical prop portion 220a having an approximately “|” shape to prevent the elastic member 120 from being separated laterally from the wiper blade assembly. Also, the prop portion 220 includes the horizontal prop portion 220b having an approximately “-” shape to prevent the elastic member 120 from being separated downward from the wiper blade assembly.

In this case, in a state where the lower surface of the elastic member is in contact with an upper surface of the horizontal prop portion, the horizontal prop portion can prevent the elastic member from being separated downward from the wiper blade assembly.

Meanwhile, the prop portion can not only prevent the elastic member from being separated laterally or downward from the wiper blade assembly, but also guide the movement of the elastic member when the elastic member moves in the longitudinal direction thereof as described above.

That is, when the end of the elastic member moves in the longitudinal direction through the entrance/exit portion during the operation of the wiper, the vertical prop portion and the horizontal prop portion can support the elastic member and guide the elastic member to move in the longitudinal direction through the entrance/exit portion.

Subsequently, referring to FIGS. 2A to 2C, the cover member 200 in accordance with the first embodiment of the present invention may include a second end portion 230 located on the side opposite to the first end portion 210 covering the end of the elastic member, and a coupling protrusion 231 located in an inner region of the second end portion.

The second end portion is fastened to the coupling cover that will be described later. As will be described later, the coupling cover includes coupling holes or coupling grooves, and each of the coupling holes or coupling grooves may be fastened to the coupling protrusion 231 of the second end portion 230.

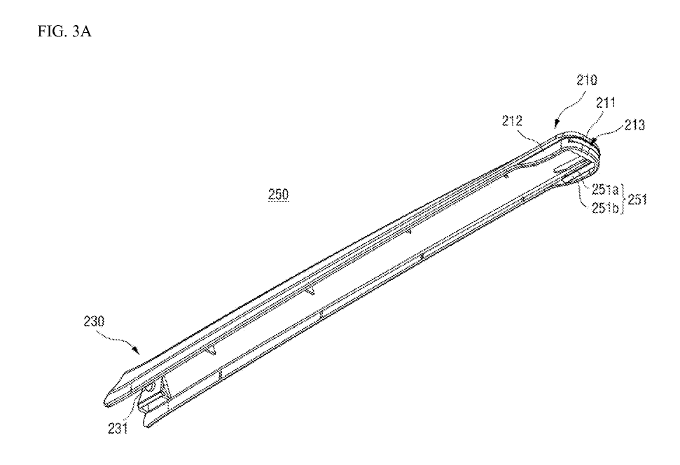

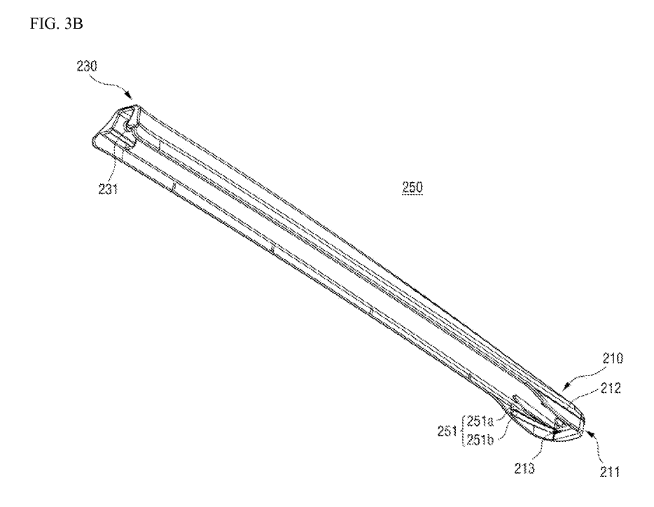

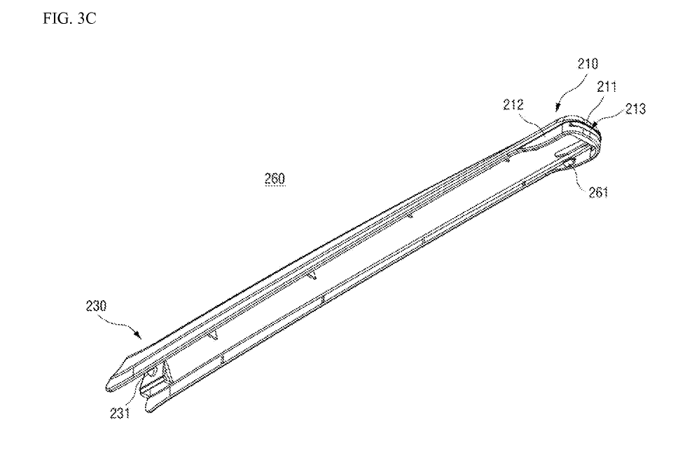

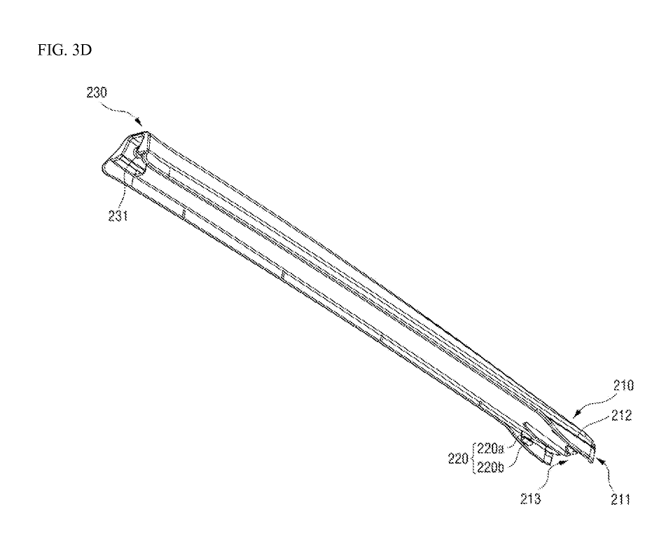

FIGS. 3A and 3B are perspective views showing a cover member of a wiper blade assembly in accordance with a second embodiment of the present invention. The cover member of the wiper blade assembly in accordance with the second embodiment of the present invention may have the same configuration as the cover member of the first embodiment except for the following description.

In the prop portion having an approximately “ [symbol] ” or “ [symbol] ” shape, which is formed in the cover member of the wiper blade assembly in accordance with the first embodiment of the present invention, the vertical prop portion and the horizontal prop portion are formed to be separated from the entrance/exit portion by a predetermined distance.

However, in a cover member 250 of the wiper blade assembly in accordance with the second embodiment of the present invention, a prop portion 251 including a vertical prop portion 251a and a horizontal prop portion 251b extends in the longitudinal direction to the front portion 211 of the first end portion 210, thereby guiding the elastic member to the entrance/exit portion when the elastic member moves back and forth through the entrance/exit portion.

FIG. 3C is a perspective view showing a cover member of a wiper blade assembly in accordance with a third embodiment of the present invention. The cover member of the wiper blade assembly in accordance with the third embodiment of the present invention may have the same configuration as the cover member of the first embodiment except for the following description.

In the cover member of the wiper blade assembly in accordance with the first embodiment of the present invention, the prop portion having an approximately “ [symbol] ” or “ [symbol] ” shape is additionally formed on the inner side surface of the cover member. However, unlike the first embodiment, the vertical prop portion may be a part of the side surface of the cover member.

That is, as shown in FIG. 3C, the inner side surface of the cover member can prevent the elastic member from being separated laterally from the wiper blade assembly. In this case, since the elastic member can be prevented from being separated laterally by the inner side surface, the vertical prop portion may be omitted.

Further, in a case where the vertical prop portion is omitted, a horizontal prop portion 261 may extend in a width direction from the inner side surface of the cover member.

In this case, although not shown in the drawing, in the cover member of the third embodiment, in the same way as the cover member of the second embodiment, the horizontal prop portion extends in the longitudinal direction to the front portion of the first end portion, thereby guiding the elastic member to the entrance/exit portion when the elastic member moves back and forth through the entrance/exit portion.

Meanwhile, in the present invention, the concept that the inner side surface of the cover member includes the prop portion having an approximately “ [symbol] ” or “ [symbol] ” shape also contains the above-described case.

That is, in the present invention, the prop portion having an approximately “ [symbol] ” or “ [symbol] ” shape may be additionally formed on the inner side surface of the cover member. Further, the vertical prop portion may be a part of the side surface of the cover member, and the horizontal prop portion may extend in the width direction from the inner side surface of the cover member, thereby forming the prop portion having an approximately “ [symbol] ” or “ [symbol] ” shape. Furthermore, the horizontal prop portion and the vertical prop portion may extend in the longitudinal direction to the front portion of the first end portion, thereby forming the prop portion having an approximately “ [symbol] ” or “ [symbol] ” shape.

FIG. 3D is a perspective view showing a cover member of a wiper blade assembly in accordance with a fourth embodiment of the present invention. The cover member of the wiper blade assembly in accordance with the fourth embodiment of the present invention may have the same configuration as the cover member of the first embodiment except for the following description.

In the cover member of the wiper blade assembly in accordance with the first embodiment of the present invention, the entrance/exit portion formed in the front portion is configured as an entrance/exit hole. However, unlike the first embodiment, the entrance/exit portion may be configured as an opening such that a lower portion of the front portion is opened.

That is, in the first embodiment, a specific surface of the cover member exists at the lower portion of the front portion, and the entrance/exit portion has an entrance/exit hole. However, in the fourth embodiment, the entrance/exit portion may be configured as an opening 213′ such that a specific surface of the cover member does not exist at the lower portion of the front portion 211.

Meanwhile, although not shown in the drawing, in the cover member of the fourth embodiment, in the same way as the cover member of the second embodiment, the horizontal prop portion and the vertical prop portion extend in the longitudinal direction to the front portion of the first end portion, thereby guiding the elastic member to the entrance/exit portion when the elastic member moves back and forth through the entrance/exit portion.

In addition, in the same way as the cover member of the third embodiment, the inner side surface of the cover member can prevent the elastic member from being separated laterally from the wiper blade assembly. In this case, since the elastic member can be prevented from being separated laterally by the inner side surface, the vertical prop portion may be omitted.

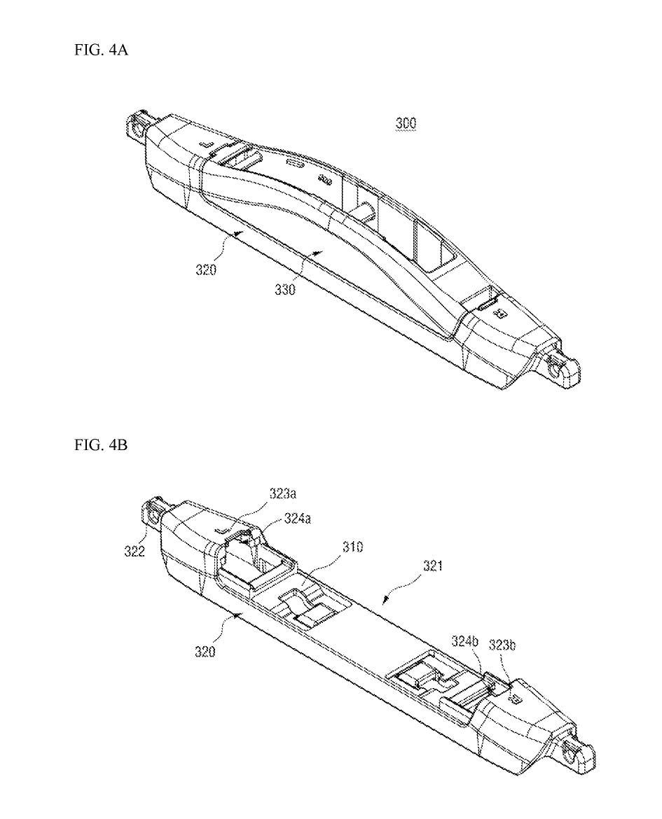

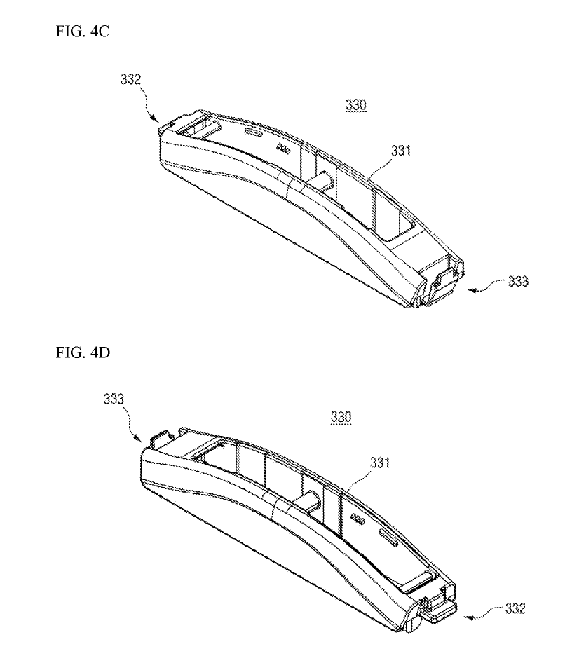

FIGS. 4A to 4D are perspective views showing the wiper connecter in accordance with the present invention. For convenience of explanation, FIG. 4B illustrates the wiper connecter of FIG. 4A without showing the adapter, and FIGS. 4C and 4D illustrate only the adapter.

Referring to FIGS. 4A to 4D, as described above, the wiper connecter 300 in accordance with the present invention may include a clamp 310 which is coupled to the elastic member (not shown), a coupling cover 320 which covers the clamp and includes a receiving portion 321, and an adapter 330 which is attachable to and detachable from the receiving portion of the coupling cover.

As described above, the coupling cover 320 includes coupling holes or coupling grooves at both ends, and each of the coupling holes or coupling grooves may be fastened to the coupling protrusion of the second end portion.

In this case, when the coupling cover 320 is fastened to the second end portion of the cover member, the cover member may be rotatably connected to the coupling cover.

For example, the elastic member supporting the adhesive member is bent at a predetermined curvature when a wiper is not operated, and is deformed while varying the curvature according to the shape of the window when the wiper is operated. When the elastic member is deformed while varying the curvature according to the shape of the window during the operation of the wiper, the coupling cover rotates with respect to the cover member so as not to prohibit the deformation of the elastic member. In this case, the elastic member may move in the longitudinal direction through the entrance/exit portion.

That is, in the present invention, when the wiper is operated, consecutively or simultaneously, the elastic member is deformed while varying the curvature according to the shape of the window, the coupling cover rotates with respect to the cover member, and the end of the elastic member moves in the longitudinal direction through the entrance/exit portion. Therefore, it is possible to provide the wiper blade assembly capable of facilitating the deformation of the elastic member when the wiper is operated.

Subsequently, referring to FIGS. 4A to 4D, the coupling cover 320 may be coupled with the clamp while covering the clamp 310 coupled to the elastic member. Further, the coupling cover may include the receiving portion 321 to/from which the adapter is attachable/detachable.

First, the adapter in accordance with the present invention will be described with reference to FIGS. 4C and 4D. The adapter 330 includes a body 331 which is inserted in the receiving portion, a support protrusion 332 which is formed at one end of the body and supported by the coupling cover and an elastic protrusion 333 which is formed at the other end of the body and engaged with and supported by the coupling cover.

Then, the coupling cover in accordance with the present invention will be described with reference to FIG. 4B. The coupling cover includes a first support portion 323a which is located at a first side of the receiving portion to support the support protrusion and a second support portion 323b which is located at a second side of the receiving portion to support the support protrusion. The first support portion may be formed to have a shape and position corresponding to those of the second support portion.

Further, the coupling cover includes a first coupling groove 324a which is located at the first side of the receiving portion and fastened to the elastic protrusion and a second coupling groove 324b which is located at the second side of the receiving portion and fastened to the elastic protrusion. The first coupling groove may be formed to have a shape and position corresponding to those of the second coupling groove.

That is, as described above, the adapter may be detachably received in the receiving portion of the coupling cover. When the adapter is attached or detached, the support protrusion of the adapter may be supported by the first support portion or the second support portion of the coupling cover, and the elastic protrusion of the adapter may be fastened to the first coupling groove or the second coupling groove.

For example, the support protrusion is supported by the first support portion and the elastic protrusion is fastened to the second coupling groove, so that the adapter can be attached to the receiving portion. On the other hand, the support protrusion is supported by the second support portion and the elastic protrusion is fastened to the first coupling groove, so that the adapter can be attached to the receiving portion.

As described above, in the present invention, since the first support portion and the second support portion are formed to have shapes and positions corresponding to each other, the support protrusion having a specific shape may be supported by the first support portion or the second support portion. Also, in the present invention, since the first coupling groove and the second coupling groove are formed to have shapes and positions corresponding to each other, the elastic protrusion having a specific shape may be fastened to the first coupling groove or the second coupling groove.

Generally, the wiper arm is connected to the driving shaft connected to the wiper driving motor of the vehicle, and the wiper blade assembly can be driven by driving the wiper arm.

In driving the wiper arm, the position of the driving shaft of the wiper arm is different according to whether the vehicle, e.g., a LH vehicle in which the driver is seated on the left side, or a RH vehicle in which the driver is seated on the right side.

Accordingly, the position where the adapter is attached to the receiving portion is determined according to whether the vehicle is a LH vehicle or RH vehicle. Generally, the adapter attachment position of the LH vehicle is opposite to the adapter attachment position of the RH vehicle.

For this reason, generally, the adapter and the coupling cover are manufactured to be applied to each of the LH vehicle and RH vehicle. However, in the present invention, since the first support portion and the second support portion are formed to have shapes and positions corresponding to each other, and the first coupling groove and the second coupling groove are formed to have shapes and positions corresponding to each other, it is possible to provide the wiper blade assembly that can be applied to both of the LH vehicle and RH vehicle.

For example, in the LH vehicle, the support protrusion is supported by the first support portion and the elastic protrusion is fastened to the second coupling groove, so that the adapter can be attached to the receiving portion. On the other hand, in the RH vehicle, the support protrusion is supported by the second support portion and the elastic protrusion is fastened to the first coupling groove, so that the adapter can be attached to the receiving portion.

Therefore, in the present invention, in fastening the adapter to the coupling cover, the first support portion and the second support portion are formed to have shapes and positions corresponding to each other, and the first coupling groove and the second coupling groove are formed to have shapes and positions corresponding to each other, thereby providing the wiper blade assembly that can be applied to both of the LH vehicle and RH vehicle.

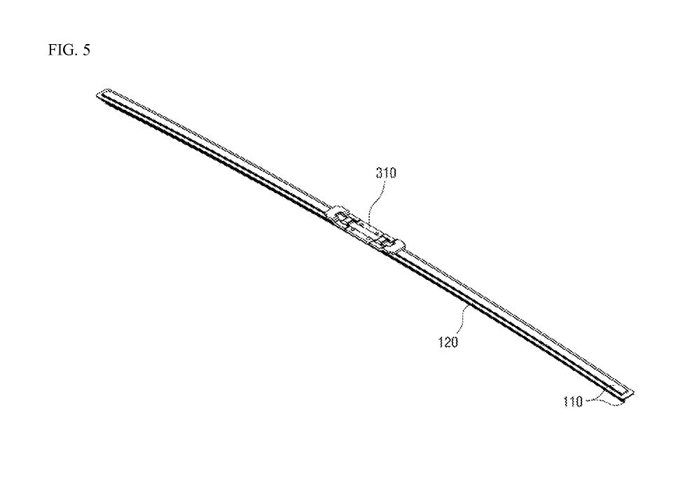

FIG. 5 is a perspective view showing a coupling state of the adhesive member, the elastic member and the clamp of the wiper blade assembly in accordance with the present invention.

As shown in FIG. 5, the adhesive member 110 of the wiper blade assembly may be fastened to the elastic member 120, and the elastic member 120 may be fastened to the clamp 310. In this case, the clamp 310 may be fastened to the coupling cover of FIG. 4B.

However, the coupling state of the adhesive member, the elastic member and the clamp in the present invention is not limited thereto.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A wiper blade assembly comprising:
an adhesive member to remove foreign substances attached to a window;
an elastic member to support the adhesive member; and
cover members, each including a first end portion to cover an end of the elastic member and extending in a longitudinal direction of the elastic member,
wherein the first end portion of the cover member includes a front portion and side portions located at both sides of the front portion,
wherein the front portion includes an entrance/exit portion allowing entrance and exit of the elastic member, and each of the side portions includes a prop portion to support the elastic member, and
wherein the prop portion includes a vertical prop portion to support a side surface of the elastic member, and a horizontal prop portion to support a lower surface of the elastic member.

2. The wiper blade assembly of claim 1, wherein an upper surface of the horizontal prop portion is in contact with a lower surface of the elastic member.

3. The wiper blade assembly of claim 1, wherein the vertical prop portion is a part of each of the side portions of the first end portion, and the horizontal prop portion extends in a width direction from each of the side portions.

4. The wiper blade assembly of claim 3, wherein the horizontal prop portion extends in a longitudinal direction to the front portion of the first end portion to guide the elastic member to the entrance/exit portion during the entrance and exit of the elastic member.

5. The wiper blade assembly of claim 1, further comprising:
a clamp coupled to the elastic member;
a coupling cover including a receiving portion to cover the clamp; and
an adapter attachable to and detachable from the receiving portion of the coupling cover.

6. The wiper blade assembly of claim 5, wherein the cover member includes a second end portion rotatably connected to the coupling cover, and the end of the elastic member moves back and forth through the entrance/exit portion during rotation of the cover member.

7. The wiper blade assembly of claim 5, wherein the adapter comprises:
a body being inserted in the receiving portion;
a support protrusion formed at one end of the body and supported by the coupling cover; and
an elastic protrusion formed at the other end of the body, and engaged with and supported by the coupling cover.

8. The wiper blade assembly of claim 7, wherein the coupling cover comprises:
a first support portion located at a first side of the receiving portion to support the support protrusion; and
a second support portion located at a second side of the receiving portion to support the support protrusion,
wherein the first support portion has a shape and position corresponding to those of the second support portion.

9. The wiper blade assembly of claim 7, wherein the coupling cover comprises:
a first coupling groove located at a first side of the receiving portion to be fastened to the elastic protrusion; and
a second coupling groove located at a second side of the receiving portion to be fastened to the elastic protrusion,
wherein the first coupling groove has a shape and position corresponding to those of the second coupling groove.
